(19) United States
(12) Patent Application Publication
(10) Pub. No.: US 2005/0075420 A1
(43) Pub. Date: Apr. 7, 2005

(54) Invisible ink

(76) Inventor: Terry Stovold, Saranac, NY (US)

Correspondence Address: SCHNADER HARRISON SEGAL & LEWIS, LLP, 1600 MARKET STREET, SUITE 3600, PHILADELPHIA, PA, 19103, US

(21) Appl. No.: 10/942,246

(22) Filed: Sep. 15, 2004

Related U.S. Application Data
(60) Provisional application No. 60/509,281, filed on Oct. 6, 2003.

(51) Int. Cl. C03C 17/00

(52) U.S. Cl. 523/161

(57) ABSTRACT

A method of invisible ink fabrication. A first ink having an activator without a leucodye is prepared. A second ink having a leucodye is prepared without an activator, which is combined with the first ink prior to color development and prior to printing. Preferably, the combined ink is printed immediately after being created. Further disclosed are items created using the ink such as toys, puzzles, stickers, coloring books, tags, labels and security devices.

This application is based on provisional application having Ser. No. 60/509,281, filing date of Oct. 6, 2003, and entitled Pressure Activated Ink, Processes and Related Products.

### BACKGROUND OF THE INVENTION

There always exists a demand for novel technologies to entertain the consumer. Many printing technologies are utilized to entertain the consumer like; invisible inks and markers, photochromic and thermochromic inks which are heat or light reactive, coin reactive inks, glitter inks and pencil inks. Encapsulated inks can also be used for games and novelty items, however, the capsules are prone to rupture due to such processes as packaging. Broken capsules cause the color to appear prematurely.

Games and other entertainment items using invisible inks are particularly well received by consumers, however, there are drawbacks to the existing technologies. Current technologies typically require an activating device to reveal the invisible inks, such as a pen or marker, which can be easily misplaced. The activating devices contain a substance not readily available except as sold with the games or items. If the activator is lost or misplaced, the game or other item is rendered useless. Accordingly, an ink that would not require a separate activating device, or would be activated by a device found in any household, would be desirable. Additionally, many types of ink used for games and novelty items are susceptible to heat degradation, and thus will not produce a reliable, quality product.

### SUMMARY OF THE INVENTION

A method of ink fabrication is disclosed. The ink is initially invisible and is activated by subjecting it to heat, usually by methods such as scratching or rubbing to create frictional heat.

In a preferred embodiment, a first ink having an activator without a leucodye is prepared. A second ink having a leucodye is prepared without an activator, which is combined with the first ink prior to color development and prior to printing. Preferably, the combined ink is printed immediately after being created, however, it can typically be printed up to five hours after combining.

The activator used may be, for example, a phenolic resin, zinc chloride bisphenol or hydroxybenzoate. Other possible ingredients for either of the initial ink parts include binders, such as polyvinyl alcohol, surfactants and grinding aids.

A plurality of combined inks can be printed onto a single substrate, each having a different leucodye. When the printed substrate is rubbed different colors will appear.

Numerous items can be created using the inks such as toys, puzzles, stickers, coloring books, tags, labels and security devices.

### DETAILED DESCRIPTION OF THE INVENTION

The present invention provides an ink, methods of forming the ink and various items produced using the ink. Advantageously, it has been found these scratch inks can be adapted for the interactive game market, because they may change from white or light color (preferably 5% reflectance, as for example per U.S. Pat. No. RE36,306), to a color simply via a scratch action. “Scratch ink” as used herein means any ink or material that produces a color change or color initiation by scratching, wiping, applying pressure or other heat producing actions. The multitudes of colors, which can appear when rubbed, make these inks extremely appealing to the end user. “Rubbed” as used herein includes, wiped, scratched, or the like.

According to the present invention, scratch inks can be used to create novel toys, puzzles, art products, educational, interactive customer verification products, novelty items and games, for example, tic-tac-toe, mazes, matching games, coloring books/pictures, quiz books, hang man games, connect the dots pictures and problem solving games, stickers, decorative items, art projects, gambling items/cards/tickets, etc. These can be implemented in any form. Examples include, placemats, cards, single pages of paper or pads of paper or other substrates, plastic films, labels, tags, stickers, various leathers or synthetic materials.

A novel two part scratch ink provided by preferred embodiments of the invention is not limited to interactive game applications and could be used as an anti-counterfeiting mechanism, to protect against illegal document duplication or as other security mechanisms. A simple rubbing action could verify the authenticity of the item. It is noted that existing two part scratch inks require a separate printing of each of the parts, creating additional manufacturing time and possible costs.

Given that inks may be rubbed by the consumer, they should also meet all ASTM regulations. Water-based scratch inks have been tested by an independent laboratory and meet all requirements of ASTM Standard F-963 for heavy metals content and NON TOXIC labeling. The testing procedure for ASTM Standard F-963 was nitric acid digestion of dried material (total), and extracted dried material with 0.07 Normal hydrochloric acid (weak acid extractable): followed by analysis by plasma emission spectrophotometry, cold vapor atomic absorption spectrophotometry and graphite furnace atomic absorption spectrophotometry.

Scratch inks are also known to be prone to some premature color development, particularly when printed on acidic or thermal coated substrates. To address this problem a novel two part scratch ink can be made to minimize or eliminate the possibility of premature color development. For example, an activator such as Bisphenol A available from Sunoco may be contained in one part, and a leucodye contained in a second part can be combined in a water-based ink. Other examples of activators are phenolic resins like HRJ-10138 or HRJ-2609 as made by Schenectady Chemicals, zinc chloride, other bisphenols and hydroxybenzoates.

In an illustrative embodiment, both the leucodye and Bisphenol A are grinded separately to the appropriate, particle size, usually 5-10 microns, for printing on a standard flexographic printing press using a 300-350 line anilox with BCM of 1.5 to 4, with a binder like polyvinyl alcohol, surfactant, defoamers, and grinding agents into two water-based inks or oil based inks, such as; Soya oil (where both activator and dye have minimal or no solubility). Depending on the printing method, the particle size could be as high as 25-30 microns and as low as 1 micron or sub micron. For the leucodye, particle size is preferably between five and ten microns. The activator particle size is preferably between five and 15 microns. Some examples of possible surfactants and grind aids are available from Rohm and Haas Chemicals under their Tamol line. Defoamers are available from Rohm and Hass and Air Products. One could produce an ink which could print and function with only a binder for example Polyvinyl Alcohol sold by Air Products under Airvol line, an activator or activators and a leucodye or leucodyes in a vehicle (water or oil) without any other additives.

The two part finish ink is preferably combined just prior to printing at a ratio of 2:1 activator to leucodye ink because if the inks are combined for at least five hours, then color development likely will occur in the ink due to the fact that Bisphenol A is partially soluble in water. A ratio of 1:1 could also be utilized depending on the volume of ink printed, but a ratio where the leucodye ink is greater than Bisphenol A ink would probably result in poor color development while rubbing or scratching. If the ratio of leucodye to activator is greater than 1:1, other additives may be utilized to improve color development. Once printed, the water evaporates and the dry ingredients are left on the substrate to be rubbed to a color change. The color change can vary depending on the leucodye in the ink. The combined ink is preferably printed within five hours of combining the two parts, more preferably within three hours, still more preferably within one hour, and most preferably immediately after combining.

Following is an illustrative example of a two-part scratch ink.

Part A Ink

Bisphenol A PC grade available from Sunoco Inc. or other bisphenol, is wet micronized in water, polyvinyl alcohol, surfactant and grind aids to a particle size of less than 15 microns with a mean around 8-10 microns. The following is a typical formula;

| INGREDIENTS | % (wt.) |
|---|---|
| Bisphenol A PC Grade | 35 |
| Water | 37 |
| Water & 20% Polyvinyl Alcohol | 27 |
| Surfactant & Grind aids | 1 |

Part B Ink

A leucodye, for example Specialty Magenta 20, 3, 3-Bis(1-butyl-2-methyl-1H-indol-3-yl)-1-(3H)-isobenzofuranone available from Noveon Hilton Davis in Cincinnati, Ohio is wet micronized in water, polyvinyl alcohol, surfactants and grind aids to a particle size of less than 10 microns with a mean around 6-7 microns. The following is a typical formula:

| INGREDIENTS | % (wt.) |
|---|---|
| Leucodye | 35 |
| Water | 37 |
| Water & 20% Polyvinyl Alcohol | 27 |
| Surfactants & Grind aids | 1 |

Due to Bisphenol A's partial solubility in water, Part A ink & Part B ink should be combined (mixed) just prior to printing at a ratio of 2:1 (2 parts PART A & 1 part PART B).

For further protection against environmental factors such as temperature and high humidity on acidic or thermal substrates or any other substrate or surface, 10% Joncryl 98 wax from Johnson Wax or other suitable water-based or non-water based wax is added to the Part A & Part B combined ink. Any wax dispersion, wax additive or other ingredient designed to withstand high humidity and temperature could possibly be useful, if it was compatible with scratch ink. The quantity of wax may vary but is preferably between 8% and 12% by weight of the combined ink.

Preferably the activator is between 30% and 40% by weight of the first ink and most preferably 35%. Also, the leucodye is preferably between 30% and 40% by weight of the second ink and most preferably 35%.

The pH of the combined ink is preferably less than seven. One or more pH adjusters, such as baking soda, may be used to assure a desirable pH. A pH that is too low (acidic) may cause premature color development.

The Part A & Part B ink is printed, preferably immediately, on the appropriate substrate or surface. The new printed ink will rub or scratch to a color change and be less susceptible to premature coloring on acidic or thermal substrates than existing scratch inks.

Low Temperature Sensitivity Scratch Ink

In a further embodiment of the invention, a scratch ink with relatively low temperature sensitivity is used to create an item such as a coloring book, stickers, placemat, etc. An amidophenol, or anilide or benzoamide with a hydroxyl group based chemical is combined with a leuco dye mixture in an ink and/or coating with a binder such as polyvinyl alcohol and is applied in the form of some image such as a shape, picture or writing, to a substrate. This image will initially be invisible. Optionally, a second image can then be applied to the substrate in a visible form, for example with a laser printer, and the first printed image will withstand the high temperatures, without developing a color change. The later application of mechanical rubbing to the printed substrate combines the chemicals to result in a color change. This techniques can be used to create coloring books, either having pages that are initially totally blank (use of only invisible images), or pages that are partially blank such as having an outline or scattered images. When blank areas of the pages are rubbed, color development will occur to reveal the invisible images. This same process can be used on other items such as placemats, sticker, labels and puzzles. Colors can be made to appear or dissipate upon application of particular temperatures.

Examples of activator chemicals for this ink with low sensitivity to high temperatures, are The activator chemicals according to the present invention comprise amidophenol, anilides and benzoamides with a hydroxyl group including N-(4-Hydroxyphenyl) acetamide, 2-Acetamidophenol, 3-Acetamidophenol, Salicylanilide, p-Hydroxybenzamide, p-Hydroxyphenyl acetamide, 3-Hydroxy-2-Napthanilide, o-Hydroxybenzanilide. One or more of the activators can be mixed with one or more leuco dyes to tailor the reaction temperature and increase or decrease the ease of physically producing color development. For children's items such as coloring books, a relatively low reaction temperature may be desirable so images can be revealed with minimal effort. The color developed by the mechanical combination of the leuco dye and the activator can be made to disappear again at various temperature ranges.

The activator in accordance with the present invention preferably has to have the characteristics of either low or no solubility in water and typical flexosolvents, a melting point preferably above 115° C. and activatable by physically combining both the activator and leuco dye ingredients. The activator also has to be stable in a flexographic ink environment.

The activator is defined as follows: 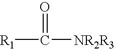
wherein R₁ is a phenolic derivative or —C₆H₄OH;
R₂ is H, a branched or unbranched alkyl group or an aryl group; and
R₃ is H, a branched or unbranched alkyl group or an aryl group; 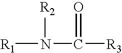
   wherein R₁ is a o-, m-, or p-phenolic group;
R₂ is H, a branched or unbranched alkyl group or an aryl group; and
R₃ is H, a branched or unbranched alkyl group or an aryl group; 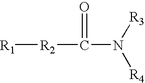
   wherein R₁ is a o-, m-, or p-phenolic group;
R₂ is a branched or unbranched alkyl group or an aryl group;
R.₃ is H, a branched or unbranched alkyl group or an aryl group; and
R4 is H, a branched or unbranched alkyl group or an aryl group. 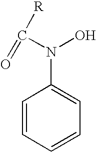
   where R═H, alkyl or aryl derivatives; or 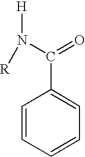
   where R=hydroxyalkyl or hydroxyaryl derivatives.

In accordance with the invention, the activator is preferably one selected from the group consisting of:
CH₃CONHC₆H₄OH
2-Acetamidophenol
3-Acetamidophenol
4-Acetamidophenol having the generic formula
CH₃ CONHCH₆H₄OH
Salicylanilide
HOC₆H₄CONHC₆H₅
p-Hydroxybenzamide
HOC₆H₄CH₂CONH₂
p-Hydroxyphenylacetamide
HOC₆H₄CH₂CONH₂
3-Hydroxy-2-Napthanilide
HOC₁₀H₆CONHC₆H₅
o-Hydroxybenzanilide
HOC₆H₄NHCOC₆H₅.

The above chemicals are combined in formulations of various ratios in order to provide tailoring of the process in accordance with the needs of the user.

The amidophenol N-4-Hydroxyphenyl acetamide has the characteristics of lower poor solubility in water and most common flexographic solvents, a melting point of 169°-170° C., reacts well with a leuco dye for good color development and it has good stability in flexographic ink environments.

A printing medium in accordance with the present invention has the characteristics of laser compatibility, that is, a melting point of higher than 115° C. and toner compatible qualities. In accordance with the present invention, a printing medium which meets these qualifications is a flexographic based ink and in particular, AWX5-92074 flexographic base because it is laser compatible with a melting point above 200° C., has excellent toner adhesion qualities and has a pH of 8.5. It was also found that the dye and the activator in accordance with the present invention produced no noticeable premature color development.

The leuco dye can be any of the previously mentioned conventional leuco dyes, preferably one with a high melting point, i.e., above 115° C. and which is stable in a flexographic base ink. In accordance with the present invention, the leuco dye CIBA GEIGY I2G Blue was found to have all of these qualities.

In a preferred embodiment of the present invention, the leuco dye and activator are wet micronized into the flexographic base with a ratio by weight of the activator to leuco dye being from about 1:1 to 8:1, preferably 4:1.

Similar properties can be obtained by using one or more of the amidophenol, or hydroxyl group containing anilides or benzoamides. Similarly, various leuco dyes may be employed to generate or enhance color development. In terms of offset printing, the activator and leuco dye must be dry micronized to the appropriate particle size then placed into an offset ink base, i.e., soya oil base, standard oil bases.

In a further embodiment of the invention items such as, coloring books, games, puzzles, etc. are created using scratch inks that rely on particular reflectance values to achieve an invisible nature. A background color is provided on a substrate having an average reflectance value. An image is printed on the background color with a contrast color having a spectral characteristic which modulates the average reflectance value by no more than 5% and has an average value equal to the average reflectance value by applying a printing medium including a binder and further consisting of a mixture of micronized color former leuco dye and micronized activator material. Preferably the micronized color former leuco dye, activator or both are non-soluble in the printing medium. In an exemplary embodiment an oil-based printing ink is used, such as an offset printing ink, but water-based inks are also in the spirit and scope of the invention.

The color former leuco dye and the activator material will change the color of the printing medium by simultaneously applying mechanical pressure and a rubbing action on the printing medium, or by other means to produce heat. Accordingly, an item such as a coloring book can be created wherein an invisible image is revealed upon application of heat such as by rubbing. The substrate can initially contain both invisible and visible images.

In a further embodiment of the invention the printing medium is covered with a first colorless continuous coating of a barrier material providing a non-porous coating of a high softening temperature lying between 210° F. and 400° F. The first colorless continuous coating is then coated with a second colorless continuous coating of the other of a micronized color former leuco dye and micronized activator material.

It is noted that although many microencapsolated dyes can be prone to premature color development, such a dye may be used. At least one of a micronized color former leuco dye and a micronized activator material with a colorless continuous coating of a barrier material is microencapsulated, preferably in an oil vehicle. A printing medium, including a binder and further consisting of the microcapsules and the other of micronized color former leuco dye and micronized activating phenolic is appied. The color former leuco dye and the activator material can then be activated to change the color of the printing medium by simultaneously applying mechanical pressure and a rubbing action on the printing medium.

According to embodiments of the invention, one of the preferred methods for printing the scratch inks is with standard flexographic printing presses. The scratch inks can also be printed by, gravure, stamping, coating, tint unit, lithographic or via any other process of deposit ink to a given substrate or surface. Any firm object such as pen cap or coin as well as a fingernail, when rubbed over the printed scratch ink, will result in the printed ink developing a color. Preferably, rubbing is done with the printed scratch ink placed on a hard, flat surface like a desk or tabletop. In an alternative embodiment, a textured underlying surface can create desired results. Different colors appear after rubbing depending on the leucodye in the ink. Any leucodye can be used. Examples include Pergascript Orange I-5R, Pergascript Red I-6B, Pergascript Green I-3G, Pergascript Yellow I-3R made by Ciba Chemicals, Specialty Magenta 20, Specialty Red 747, Specialty Black 34, Specialty Magenta 16, Specialty Orange 14, Specialty Blue 1, by Noveon Hilton Davis, or other color formers whether or not synthetic organic coloring matter.

When printing with these inks a sheet of white paper or other substrate can be created, which will rub to a number of different colors depending on how many inks having different leucodyes are printed. For example, if you have a six color flexographic printing press you can have six different scratch inks, which will each rub to a different color. It is noted that the substrate does not have to be white, but can be any color provided that the inks will show up when rubbed. Due to the fact that printing units are typically at a premium there exists a need to minimize the number of printing units, but still have as many different colors appearing after rubbing. This can be achieved by a modified process printing such as four or six color process. Process printing is essentially printing process colors (i.e.: red, blue, yellow, black) on top of one another with different screens or tints to create a different color other than the process colors in each of the printing units. For example, if only four white scratch inks are utilized each rubbing to a different color an endless number of different colors can appear when rubbed. Due to the nature of many scratch inks a screen of less than 30% use in process printing would be very ineffective because not enough ink is present in a given area (i.e.: 1 square inch), resulting in the printed scratch ink appearing extremely weak (which means only 30% or less of the scratch ink is printed in a given area) or hardly noticeable when rubbed.

To allow for easier rubbing and color development of the inks, the scratch inks can be printed on a coated substrate. Preferably the coating reduces or eliminates absorption of the ink by the substrate such as coated machine calendared or surface treated substrates. An example of acceptable coated material is 60# C2S coated supplied by Wallace Thomas Packaging, of course every paper company offers several lines of coated papers, which would also be suitable. The coating need only be on the side of the paper on which the ink will be printed, however, coating on the other side may add to the integrity of the paper. Since the inks will have less absorption to such substrates they can be easily rubbed with a paper towel or tissue with minimal smearing and sharp color. If a fingernail or hard object rubs these scratch inks printed on coated or hard smooth substrates, they may tend to smear, but it allows for individuals with minimal rubbing skills to enjoy the technology, for example very young children.

Reflectance Value Dependent Scratch Inks

An additional method of creating invisible ink items such as games and art products, is by applying inks with particular reflectance values. A background color is printed on an item having a uniform reflectance of a given average reflectance value. (An average reflectance, corresponds to the prescribed overall uniform reflectance of the background of the original item.) A second printing is performed on the background with a contrast color having a spectral characteristic which modulates the average reflectance value by no more than 5% and which also has an average value essentially equal to the average reflectance value of the background. The step of printing the contrast color comprises further applying a printing medium including in one instance a mixture of micronized color former leuco dye, a micronized activator, such as an activator phenolic resin or an activator bisphenol or an activator hydroxybenzoate and a binder. The color revealing method comprises thereafter activating the color former leuco dye and the activating phenolic resin or other micronized activator to change the original color of the printing medium preferably by simultaneously applying localized mechanical pressure and a rubbing action on the printing medium to create heat. Alternatively, printing the contrast color comprises applying a printing medium including one of micronized color former leuco dye and a micronized activator, such as an activator phenolic resin, covering the printing medium with a first colorless continuous coating of a barrier material and covering the continuous coating with a second continuous coating of the proper contrast color of the other of a micronized color former leuco dye and micronized activator, such as an activator phenolic resin. The color revealing method comprises activating the color former leuco dye and the activating phenolic resin to change the color of the printing medium preferably by simultaneously applying localized mechanical pressure sufficient to break the barrier coating and a rubbing action on the printing medium.

In another embodiment, printing the contrast color comprises applying a printing medium including a mixture of micronized color former leuco dye and a micronized activator where one or both of such micronized materials is encapsulated in microcapsules of which the walls constitute a proper barrier material and the color revealing method comprises activating the color former leuco dye and the activating phenolic resin or other micronized activator material to change the color of the printing medium preferably by simultaneously applying a localized mechanical pressure sufficient to break the walls of the microcapsules and a rubbing action on the printing medium.

In a further embodiment, printing comprises applying a printing medium with the proper contrast color but also including a microencapsulated photochromic dye only sensitive to intense radiation. In this embodiment the color revealing method comprises activating the photochromic dye to change the color of the printing medium.

Any spectral characteristic that modulates the chosen average with a modulation amplitude that is within 5% of the average, can be adopted. These characteristics will visually correspond to describable shades.

The key element is to ensure that the average reflectance of the general background and the average of the modulation shade are practically equal. When the average reflectivity is less than around 80%, i.e. the background is grey, any straight overprinting of the modulating color will result in an average reflectance lower than the background reflectance which is not acceptable in this process.

In accordance with an embodiment of the invention a small percentage, typically 2% to 10% of either a color former leuco dye or an activator such as a phenolic resin, a bisphenol or a hydroxybenzoate which can be dissolved in the solvent vehicle or suspended in water based inks and thus be conveyed to the printed information portions of the original item, is introduce in the printing medium. The chemical color revealing process consists of applying to the item the complimentary chemical, i.e. when the printing ink contains the activator, the color revealing process is performed with a color former leuco dye carrying applicator. On the other hand, when the printing ink is prepared with the addition of a color former, the color revealing process is performed with an activator carrying applicator. Examples of such leuco dyes are: Copikem 14, Copikem Magenta, Copikem 6, Copikem 4 made by Hilton-Davis, Pergascript Orange I-5R, Pergascript Red I-6B, Pergascript Green I-3G, Pergascript Yellow I-3R made by Ciga-Geigy, Reakt Red 448, Reakt Yellow 186 made by BASF, either alone or in combination. Examples of such activating phenolic resins are: zincated, modified alkyphenol activator HRJ-10138; the Alkylphenol Novolac resin activator HRJ-2609 as made by Schenectady Chemicals Inc.; the chemical zinc chloride ZnCl.sub.2, some bisphenols and hydroxybenzoates either alone or in combination.

Other reactive pairs of chemicals can be chosen as well with one of the pair inserted in the ink while the other is used for revealing color.

In one embodiment, the leuco dye and activator components (referred hereinafter as chemicals A and B) are physically mixed in the printing ink while they are chemically kept separate. This is achieved by one of a number of configurations. In one case, to achieve the chemical separation, the two chemicals are prevented from being dissolved in a solvent. Instead they are first mechanically micronized into extremely fine submicron sized particles. This submicronization process is fundamentally important in order to allow the integration of these particles into a very smooth ink structure. In a further embodiment of the invention, the submicronized chemicals A and B are disposed in an aqueous solution containing a small percentage of polyvinyl alcohol or polyvinyl acetate or any other well known binder materials. The sufficient amount of the combination of ordinary ink colorants is then added to the mixture, such that when this combination is used as an ink, for example, in a flexographic printing process, the printed information has a pale visible color characteristic.

In another embodiment of the invention, the submicronized chemicals A and B can be disposed in a properly chosen offset ink oil base vehicle such as soya oil base offset ink vehicles, where at least one of A or B and preferably both A and B are not soluble, and thus the intimately mixed chemicals A and B do not react. A sufficient amount of the combination of ordinary ink colorants is then added to the mixture such that when this combination is used as an offset ink, for example, the printed information has a pale visible color characteristic.

When the print is subjected to heat such as by a simultaneous mechanical pressure and brisk rubbing action, the micronized particles A and B melt and merge into each other and the color characteristic of their combination is developed, as required by the color revealing process. This result is achieved with greater or lesser ease depending upon the choice of the activator. For example, submicronized D8 (4-hydroxy 4-isopropoxy diphenyl sulfone) compared to zincated alkylphenol resin lends itself to easier reaction in the leuco dye upon rubbing. This action is coined the “rub and reveal” action. Clearly the above invention can be implemented by extending this concept to a number of other combinations of dispersion vehicles that can keep at least one or better both A and B in an undissolved state, such vehicles are known to those skilled in the field of ink making and related techniques. This invention is meant to cover all such variations.

While the invention has been described by illustrative embodiments, additional advantages and modifications will occur to those skilled in the art. Therefore, the invention in its broader aspects is not limited to specific details shown and described herein. Modifications, for example, to the types and ratios of ingredients, printing methods and product types may be made without departing from the spirit and scope of the invention. Accordingly, it is intended that the invention not be limited to the specific illustrative embodiments, but be interpreted within the full spirit and scope of the appended claims and their equivalents.

1. A method of ink fabrication comprising:
preparing a first ink having a color developer activator without a color former leucodye;
preparing a second ink having a color former leucodye without a color developer activator;
combining the first and second inks prior to a color development.

2. The method of claim 1 wherein the first and second inks are prepared within five hours of printing.

3. The method of claim 1 wherein the activator is selected from the group consisting of phenolic resin, zinc chloride bisphenol and hydroxybenzoate.

4. The method of claim 1 further comprising grinding one or more of the activator and leucodye to a particle size of less than 30 microns.

5. The method of claim 4 comprising grinding the leucodye to a particle size of between 5 and 10 microns.

6. The method of claim 4 comprising grinding the activator to a particle size of between 5 and 15 microns.

7. The method of claim 1 further comprising combining at least one of the activator and leucodye with a binder.

8. The method of claim 7 wherein the binder is a polyvinyl alcohol.

9. The method of claim 1 wherein the ratio of activator to leucodye is greater than 1:1.

10. The method of claim 9 wherein the ratio of activator to leucodye is about 2:1.

11. The method of claim 1 further comprising printing the combined first and second inks onto a substrate.

12. The method of claim 11 wherein printing is performed by a process selected from the group consisting of flexographic, gravure, stamping, coating, tint unit and lithographic.

13. The method of claim 12 wherein printing is performed by a four or six color flexographic printing process.

14. The method of claim 11 further comprising printing a plurality of combined inks onto a single substrate, each having a different leucodye.

15. The method of claim 1 further comprising applying heat to develop the combined ink.

16. The method of claim 15 wherein heat is generated by friction.

17. The method of claim 1 further comprising adding an ingredient to protect against one or more environmental factors to one or more of the inks selected from the group consisting of first ink, second ink and combined ink.

18. The method of claim 17 wherein the protecting ingredient is a wax.

19. The method of claim 17 wherein the protecting ingredient comprises between 8% and 12% by weight of the combined ink.

20. The method of claim 1 wherein the first and second inks are water-based inks.

21. The method of claim 1 wherein the first and second inks are oil-based inks.

22. The method of claim 1 wherein the leucodye is a synthetic organic color former.

23. The method of claim 1 further comprising combining the activator with one or more components selected from the group consisting of binder, surfactant, defoamer and grinding agent.

24. The method of claim 1 further comprising printing the combined ink on a coated or treated substrate to reduce or eliminate ink absorption into the substrate.

25. The method of claim 1 further comprising printing the combined ink on a substrate to create an item selected from the group consisting of toy, puzzle, art product, educational product, customer verification product, game, book, sticker, ticket, placemat, card, tag and label.

26. The method of claim 1 further comprising wet micronizing the first ink in water and one or more components selected from the group consisting of polyvinyl alcohol, surfactant and grinding aid.

27. The method of claim 1 further comprising wet micronizing the second ink in water and one or more components selected from the group consisting of polyvinyl alcohol, surfactant and grinding aid.

28. The method of claim 1 wherein the activator is between 30% and 40% of the first ink.

29. The method of claim 1 wherein the leucodye is between 30% and 40% of the second ink.

30. The method of claim 1 further comprising printing the combined ink onto an item a security device.

31. The method of claim 1 further comprising adjusting the pH to about 7.

32. An ink formed by the method of claim 1.

33. An item selected from the group consisting of toy, puzzle, art product, educational product, customer verification product or game, book, sticker, ticket, placemat, card, tag and label having applied to it an ink formed by the method of claim 1.

34. An ink mixed from a first ink and a second ink wherein:
the first ink comprises a leucodye without an activator; and
the second ink comprises an activator without a leucodye.

35. The ink of claim 34 wherein the first ink further comprises one or more components selected from the group consisting of polyvinyl alcohol, surfactant and grinding aid.

36. The ink of claim 34 wherein the second ink further comprises one or more components selected from the group consisting of polyvinyl alcohol, surfactant and grinding aid.

37. The ink of claim 34 further comprising a wax.

38. The ink of claim 34 wherein the activator is selected from the group consisting of phenolic resin, zinc chloride bisphenol and hydroxybenzoate.

39. The ink of claim 34 further comprising a pH adjuster.

40. A game comprising an ink fabricated according to claim 1.

41. A sticker comprising an ink fabricated according to claim 1.

42. A coloring book comprising an ink fabricated according to claim 1.

43. A label comprising an ink fabricated according to claim 1.

44. A tag comprising an ink fabricated according to claim 1.

45. A security device comprising an ink fabricated according to claim 1.

46. An art item comprising:
a substrate; and
one or more mixtures of a carrier, a leuco dye and an activator;
wherein the activator is at least one selected from the group consisting of amidophenol, anilides with hydroxyl groups and benzoamides with hydroxyl groups; and
wherein the one or more mixtures are applied to the substrate so that when subjected to heat one or more colors appear.

47. The art item of claim 46 wherein the one or more mixtures are applied to the substrate to form an image.

48. The art item of claim 46 further comprising a visible ink applied to the substrate to form an image.

49. The art item of claim 46 further comprising a plurality of substrates having the one or more mixtures applied thereto, wherein the substrates are in the form of a book.

50. A method of forming an item comprising:
providing a substrate for an art item or game item;
providing a composition comprising one or more mixtures of a carrier, a leuco dye and an activator on the substrate to form an invisible image;
wherein the activator is at least one selected from the group consisting of amidophenol, anilides with hydroxyl groups and benzoamides with hydroxyl groups.

51. The method of claim 50 further comprising:
providing a plurality of substrates having the one or more mixtures applied thereto wherein the substrates are formed into a book.

52. The method of claim 50 further comprising applying a visible ink to the substrate to form an image.

53. A method for forming a product comprising the steps of:
providing a background color on a substrate for an art item or game item having an average reflectance value; and
printing an image on the background color with one or more contrast colors, each having a spectral characteristic which modulates the average reflectance value by no more than 5% and has an average value equal to the average reflectance value by applying a printing medium including a binder and further consisting of a mixture of micronized color former leuco dye and micronized activator material and wherein at least one of the micronized color former leuco dye and activator is non-soluble in the printing medium.

54. The method according to claim 53, wherein the step of applying a printing medium comprises applying an oil based printing ink.

55. The method according to claim 54, wherein the oil based printing ink is an offset printing ink.

56. The method according to claim 53, further comprising activating the color former leuco dye and the activator material to change the color of the printing medium by simultaneously applying a rubbing action on the printing medium.

57. The method of claim 53 further comprising applying a visible ink to the substrate to form an image.

58. The method of claim 53 further comprising compiling a plurality of the printed substrates to form a book.

59. A method for forming a product with scratch ink, comprising the steps of:
providing a background color on a substrate for an art item or game item having an average reflectance value; and
printing an image on the background color with one or more contrast colors, each having a spectral characteristic which modulates the average reflectance value by microencapsulating at least one of a micronized color former leuco dye and a micronized activator material with a colorless continuous coating of a barrier material and applying a printing medium including a binder and further consisting of the microcapsules and the other of micronized color former leuco dye and micronized activating phenolic resin.

60. The method according to claim 59 further comprising activating the color former leuco dye and the activator material to change the color of the printing medium by applying a rubbing action on the printing medium.

61. An art or game item fabricated at least in part by the method of claim 53.

62. The art or game item of claim 61 selected from the group comprising coloring book, game and placemat.
